(19) United States
(12) Patent Application Publication
(10) Pub. No.: US 2026/0261067 A1
(43) Pub. Date: Sep. 3, 2026

(54) LUG-COVER ASSEMBLY AND ASSOCIATED DRIVE SYSTEM

(71) Applicant: SOMFY ACTIVITES SA, CLUSES (FR)

(72) Inventors: Agnès PROMMER, CLUSES (FR); Bessem BOU AOUINA, CLUSES (FR); Justin SOURIVONG, CLUSES (FR); Julien CALAMAND, CLUSES (FR); Jacky CHAUSSEE, QUINCY VOISINS (FR)

(21) Appl. No.: 18/993,294

(22) PCT Filed: Jul. 12, 2023
(86) PCT No.: PCT/EP2023/069367

§ 371 Date: Jan. 10, 2025

(30) Foreign Application Priority Data
Jul. 13, 2022 (FR) FR2207224

(51) Int. Cl. H01R 13/422; H01R 4/18; H02K 7/14

(52) U.S. Cl. CPC H01R 13/422; H01R 4/184; H02K 7/14

(57) ABSTRACT

A lug-cover assembly comprising a lug (2) with a termination (22) for connection to a terminal of an electrical component, and a cover (5) with: an insertion opening (55) for the lug (2), a front locking abutment (66) for preventing the lug (2) from coming out when the lug (2) is in a nominal orientation, and a connection end (52) receiving the connection termination (22) when the lug (2) is in the nominal orientation. To reduce a risk of incorrect assembly, the cover (5) comprises a rear retaining abutment (72) so that, when the lug (2) is orientated in an incorrect orientation, the lug (2) abuts the rear retaining abutment (72) and is thereby held back from the connection end, the rear retaining abutment (72) being arranged to allow the rear locking abutment (34) to pass when the lug (2) is orientated in an incorrect orientation.

This invention relates to a lug-cover assembly and a drive system for operating a closure, occultation or solar protection device comprising such a lug-cover assembly.

It is known to use a lug to connect a conductor cable to a rigid terminal on an electrical component. A first end of the lug is crimped to the conductor cable and the second end of the lug forms a connector which the terminal of the component can be reversibly plugged into. EP765003A1 discloses an example of a known lug, obtained by folding a cut metal sheet.

This known type of lug can in particular be used in the context of a closure, occultation or solar protection device, as described in EP1487076A1. In this example, a single-phase asynchronous motor drives a load, such as a mobile and/or rollable screen like a blind, roller shutter, or sliding door. The motor is connected to a single-phase power supply with a phase-shifting capacitor. To ensure this connection, each terminal of the capacitor can be plugged into a respective lug, each lug also being crimped with two conductor cables, one connecting the lug to one of the two windings of the motor, the other connecting the lug to the phase of the single-phase electrical supply.

For this particular application, or others where the electrical levels involved may be relatively high, for example because of the electrical energy likely to be stored in the capacitor, it is desirable for the lug to be electrically insulated from the outside to prevent accidental electrical contact with another component of the device or with a person. For this purpose, it is known to fit the lug with an insulating cover, which surrounds the lug to insulate it electrically.

Internally, the insulation cover comprises a flexible blade so that, when the lug is correctly inserted into the cover, the flexible blade snaps onto at least one tooth provided in relief on the lug, to prevent the lug from coming out of the cover. Once the lug has been snapped on, the cover is permanently attached to the lug, as the flexible blade inside the lug cannot be reached from the outside. In some cases, the permanent nature of this attachment can be seen as an initial disadvantage. Another disadvantage is that the cover allows the lug to be fitted incorrectly, where the lug is received upside down in the cover. If the cover is accidentally fitted in this way, the tooth or teeth of the lug are directed away from the flexible blade, so that the flexible blade does not engage with the tooth or teeth of the lug and the cover cannot be attached to the lug. If the lug is pushed far enough into the cover in this incorrect orientation, the lug may get pinched between the flexible blade and the opposite wall of the cover, so that the technician in charge of the lug-cover assembly may believe he has performed assembly correctly, when in fact the cover is not being held on the lug. In addition, incorrect positioning of the lug is likely to cause the cover to partially obstruct the coupling of the lug with the terminal of the component. There is then a risk that the lug will unexpectedly come loose from the terminal of the component, thus leaving said terminal exposed. As the cover is not retained on the lug, it is likely to come off the lug in turn, leaving the lug exposed even though it is electrically conductive and connected to the power supply via the conductive cable. If the component is a capacitor, the fact that the terminal is exposed can cause electrical problems, linked to a residual charge stored in the capacitor.

The invention aims to remedy the drawbacks of the prior art by providing a new lug-cover assembly that reduces the risk of incorrect assembly.

The object of the invention is a lug-cover assembly comprising a lug, which is electrically conductive and which comprises: a base, configured to be permanently attached to at least one conductive cable, and a connection termination, integral with the base and configured to be coupled with a terminal of an electrical component to electrically connect the terminal to said at least one conductive cable via the lug. The lug-cover assembly comprises a cover, which is electrically insulating and comprises: an insertion opening, the lug being configured so as to be inserted into the cover, in an insertion direction, by first passing the connection termination through the insertion opening, a front locking abutment, which bears against a rear locking abutment belonging to the lug, in the insertion direction, when the lug is positioned in the cover in a nominal orientation, to prevent the lug from coming out of the cover via the insertion opening, and a connection end, which is arranged in the insertion direction relative to the insertion opening, which receives the connection termination when the lug is positioned in the cover in the nominal orientation and which has a connection opening, intended to be traversed by the terminal of the electrical component when the connection termination is connected to said terminal, while the lug is positioned in the cover in the nominal orientation.

According to the invention, the cover comprises a rear retaining abutment separate from the front locking abutment, the rear retaining abutment being arranged between the insertion opening and the connection opening so that, when the connection termination of the lug is inserted into the insertion opening of the cover with the lug orientated incorrectly, the lug abuts against the rear retaining abutment in the insertion direction, and is thereby held back from the connection end, the rear retaining abutment being arranged to allow passage of the rear locking abutment when the lug is inserted into the cover in the nominal orientation.

The idea behind the invention is that, while the insertion opening is advantageously large enough for the base to pass through it when the lug is in the nominal orientation, thereby incidentally allowing the lug to be inserted with the incorrect orientation, the lug inserted with the incorrect orientation is retained by the rear retaining abutment, preventing the lug from being inserted any further. In other words, the lug, when it comes up against the rear retaining abutment, is held back from the connection end, meaning that the insertion of the lug into the cover is clearly revealed to be incomplete in the eyes of the technician. In particular, at least part of the base of the lug can be designed so that it protrudes from the cover through the insertion opening, which is easily visible to the technician. For the purposes of the invention, the incorrect orientation is preferably an upside-down orientation.

Furthermore, incomplete insertion of the lug into the cover when the lug is in the incorrect orientation causes the cover to not retain the lug within it. Preferably, if the front locking abutment is formed by a deformable retaining blade, the rear retaining abutment prevents the lug being inserted with the incorrect orientation until the lug is firmly pinched within the cover by the retaining blade. As the lug is not held in place or is only slightly pinched, the technician is led to understand that the lug has been fitted in the incorrect orientation.

On the other hand, when the lug is inserted into the cover in the nominal orientation, the lug advantageously does not come into abutment against the rear retaining abutment. At the very least, the rear retaining abutment allows the lug to be inserted even when the lug is in its nominal orientation until the rear locking abutment abuts the front locking abutment to prevent the lug from coming out.

Preferably, when the removal of the lug is prevented by abutment of the front locking abutment against the rear locking abutment, the lug is fully received in the cover. Preferably, when the lug is abutting in the insertion direction against the rear retaining abutment, the base protrudes out of the cover through the insertion opening.

Preferably, the rear retaining abutment is formed on a tubular wall of the cover.

Preferably, the cover comprises two retaining ribs, which form the rear retaining abutment, the two retaining ribs being arranged longitudinally between the connection end and the insertion opening and transversely on either side of the insertion opening.

Preferably, the cover comprises a bottom wall, connecting the insertion opening to the connection opening. Preferably, the lug comprises at least one tooth, which projects transversely from the connection end and forms the rear locking abutment. Preferably, when the lug is positioned in the cover in the incorrect orientation, the lug rests against the bottom wall via said at least one tooth, the lug thus being held in an oblique orientation relative to the insertion direction, about a lateral axis perpendicular to the insertion direction.

Preferably, the lug comprises a back, which connects the connection termination to the base and which is transversely opposite the rear locking abutment. Preferably, the lug is slidably guided in the insertion direction by sliding the back along the bottom wall, when the lug is inserted into the cover in the nominal orientation. Preferably, the lug comes to rest against the rear retaining abutment via the back when the lug is positioned in the cover in the incorrect orientation.

Preferably, the cover comprises an intermediate opening, arranged between the insertion opening and the connection opening and emerging in the interior of the cover. Preferably, the cover comprises a retaining blade, which is arranged in the intermediate opening, a free end of which forms the front locking abutment, the retaining blade being resiliently deformable, between: a locking configuration, where the front locking abutment is positioned to bear against the rear locking abutment to prevent the lug from coming out, and an unlocking configuration, where the front locking abutment does not prevent the lug from coming out of the cover, even when the lug is positioned in the cover in the nominal orientation. Preferably, the retaining blade is configured so that: it can be brought into the unlocking configuration from the outside of the cover via the intermediate opening, when the retaining blade is in the locking configuration, and resiliently returns to the locking configuration when the retaining blade is in the unlocking configuration.

Preferably, the cover is configured so that the front locking abutment can be moved from the locking configuration to the unlocking configuration by moving the front locking abutment away from the lug using a tool.

Preferably, the intermediate opening is delimited by at least one edge belonging to the cover, said at least one edge forming a rib which is raised towards the outside of the cover.

Another object of the invention is a drive system for operating a closure, occultation or solar protection device, comprising: the lug-cover assembly as defined above, the lug being positioned in the cover in the nominal orientation; an electric motor; a conductor cable, electrically connecting the electric motor and the lug, being permanently attached to the base of the lug; and an electrical component, consisting of a capacitor and having a terminal coupled with the connection termination of the lug, through the connection opening of the cover.

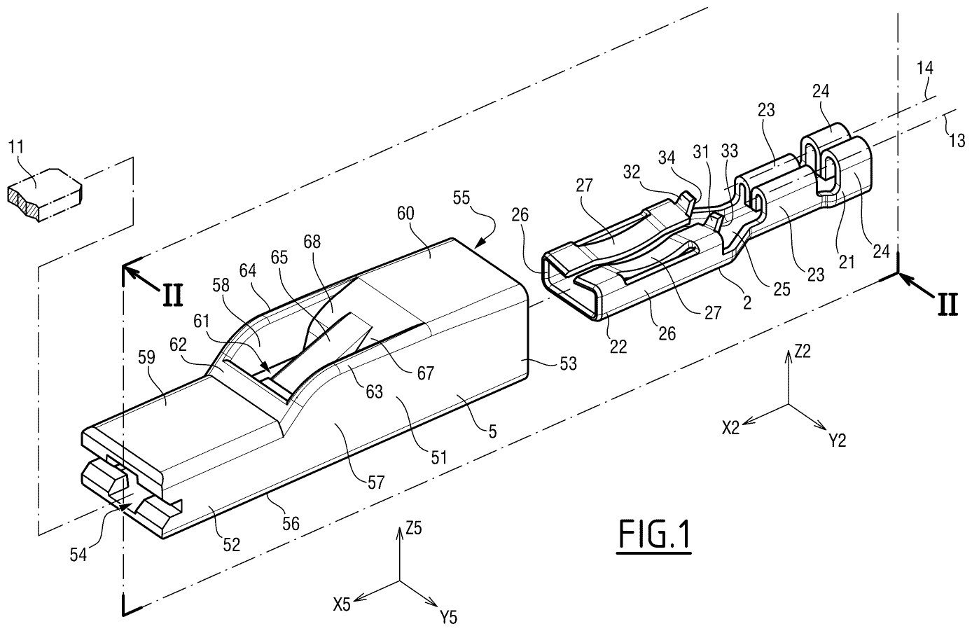

FIG. 1 is an exploded perspective view of a lug-cover assembly, with a lug and cover shown separately.

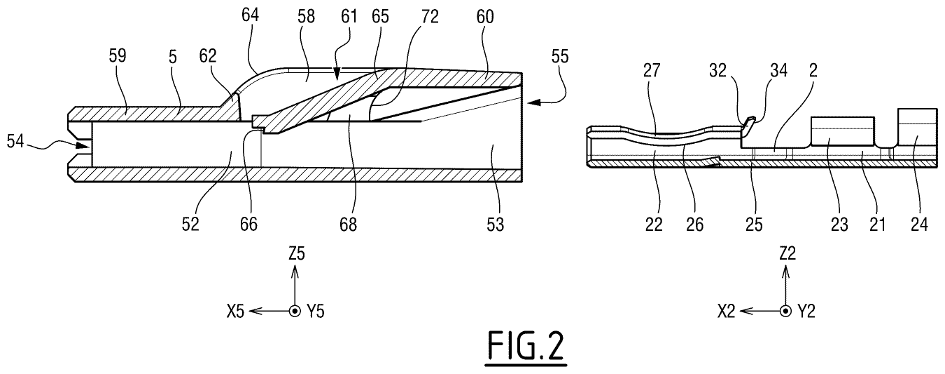

FIG. 2 is a longitudinal cross-section of FIG. 1, in the plane II-Il.

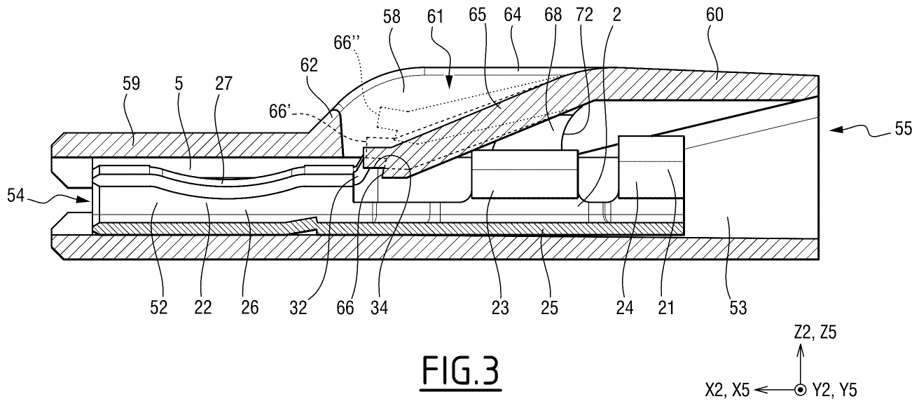

FIG. 3 is a cross-section similar to FIG. 2, where the lug is received in the cover in a nominal orientation.

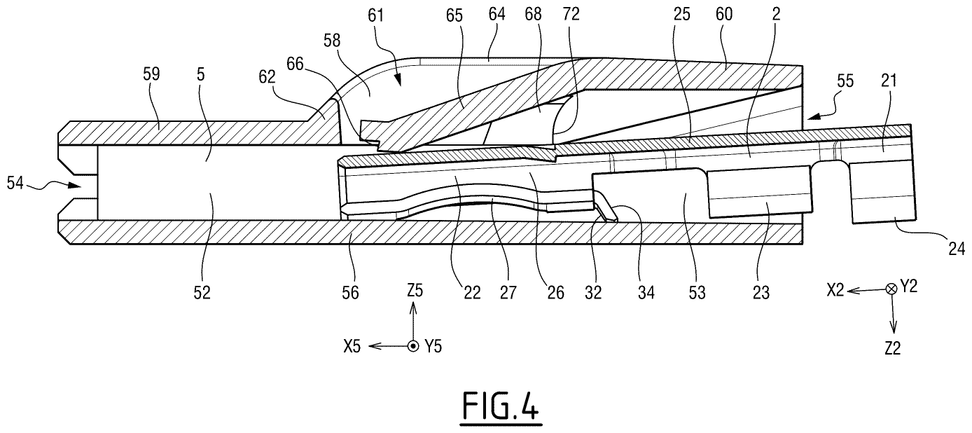

FIG. 4 is a cross-section similar to FIGS. 2 and 3, where the lug is received in the cover in an incorrect orientation.

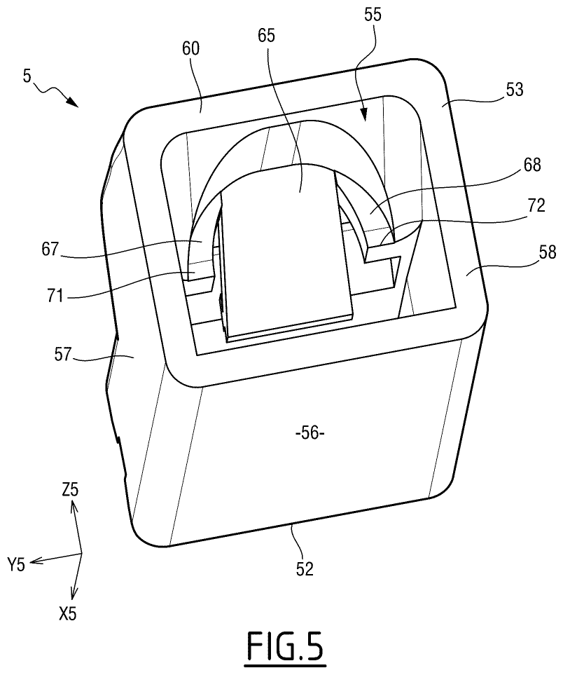

FIG. 5 is a perspective view of the lug from the previous figures, seen from another angle.

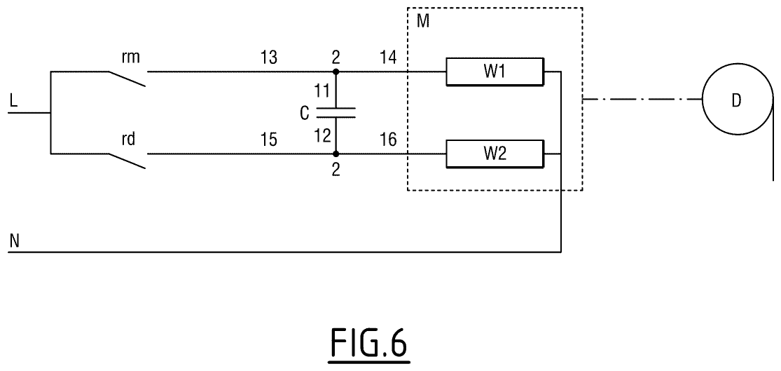

FIG. 6 is an electrical schematic of a drive system, operating a closure, occultation or solar protection device and comprising two lug-cover assemblies conforming to those of FIGS. 1 to 5.

FIG. 6 schematically shows a drive system, including an electric motor M, a capacitor C, two switches rm and rd, a phase pole, and a neutral pole of a single-phase power supply. The single-phase power supply is advantageously low-voltage, for example between 100V and 400V. The motor M is, for example, a single-phase asynchronous motor with two windings W1 and W2. When the motor M is running, it mechanically activates a closure, occultation or solar protection device D, comprising a roll-up or mobile screen, such as a roll-up blind, a roller shutter, a sliding shutter, a curtain, a sliding door, etc. The capacitor C is advantageously a phase-shifting capacitor.

A first respective pole of the switches rm and rd is connected to the phase pole L. A second pole of the switch rm is connected to a first lug 2 via an electrically conductive cable 13. The first lug 2 is connected to a terminal 11 of the capacitor C. The first lug 2 is connected to a first terminal of the winding W1, via a conductive cable 14. A second pole of the winding W1 is connected to the neutral pole N. A second pole of the switch rd is connected to a second lug 2 via an electrically conductive cable 15. The second lug 2 is connected to a terminal 12 of the capacitor C. The second lug 2 is connected to a first terminal of the winding W1, via a conductive cable 16. A second pole of the winding W2 is connected to the neutral pole N. In other words, the winding W1 and the terminal 11 of the capacitor C are connected to the pole L via the switch rm, while the winding W2 and the terminal 12 of the capacitor C are connected to the pole L via the switch rd.

To make the motor M rotate in a first direction, for example an ascending direction of the device D, the switch rm is closed and the switch rd is opened. The windings W1 and W2 are then supplied with electrical energy by the phase pole L, via the switch rm and the conductor 13. The winding W2 receives current out of phase with the winding W1 because the current flowing through the winding W2 passes through the phase-shifting capacitor C. To make the motor M rotate in the opposite direction, for example a descending direction of the device D, the switch rd is closed and the switch rm is opened. The windings W1 and W2 are then supplied with electrical energy by the phase pole L, via the switch rd and the conductor 15. The winding W1 receives current out of phase with the winding W2 because the current flowing through the winding W1 passes through the phase-shifting capacitor C.

EP1487076A1 describes another drive system suitable for the invention, in particular with a drive motor corresponding to the motor M described herein and a permanent capacitor corresponding to the capacitor C described herein.

Each conductor cable 13, 14, 15 and 16 comprises an electrically conductive core, for example a single-strand or braided multi-strand core, and a tubular electrically insulating sheath enveloping the core to insulate it electrically from the outside.

Each lug 2 shown in FIG. 6 is connected to one of the terminals of the capacitor C, to electrically connect that terminal to two electrically conductive cables, one connected to the phase pole L, the other connected to the motor M. Each lug 2 belongs to a lug-cover assembly shown in detail in FIGS. 1 to 5, which comprises, in addition to the lug 2, a cover 5 shown on its own in FIG. 5. Here, the lug-cover assembly

The lug 2 is electrically conductive, for example by being made entirely of an electrically conductive material, for example a conductive metal such as a copper-based alloy. The lug 2 defines a longitudinal direction X2 and two transverse directions, namely a lateral direction Y2 and a height direction Z2. The directions X2, Y2 and Z2 are perpendicular to each other and are fixed relative to the lug 2.

As shown in FIGS. 1 to 4, the lug 2 comprises a base 21 and a connection termination 22. The termination 22 is arranged in the direction X2 with respect to the base 21. Preferably, the lug 2 is made entirely from a single sheet of metal, which is cut and permanently deformed by bending to form both the base 21 and the connection termination 22. An example of a lug obtained using this method is described in EP765003A1.

The base 21 is configured to be permanently, i.e. non-removably, attached to two conductor cables, in this case the cables 13 and 14, symbolised by dashed lines. To this end, for each cable 13 and 14 to be fastened, the base 21 preferably comprises a fastener 23, forming a tunnel or clamp parallel to the direction X2, and a fastener 24, forming another tunnel or clamp, coaxial with that of the fastener 23. The ends of the cables received are orientated parallel to the direction X2, and point in the direction X2. The fastener 23 is arranged in the direction X2 with respect to fastener 24, i.e. between the termination 22 and the fastener 24. The two fasteners 23 are advantageously distributed side by side in the direction Y2. The two fasteners 24 are advantageously distributed side by side in the direction Y2.

The end of each conductor cable comprises a stripped end belonging to the core, received in the fastener 23. That stripped end is then folded over the stripped core end, so as to crimp the stripped core with the fastener 23, to ensure both electrical connection and permanent retention of the cable in question with respect to the lug 2. The end of each cable also comprises a sheath end belonging to the sheath, set back from the stripped end of the core. This sheath end is received in the fastener 24, which is folded around the sheath end, thus crimping the sheath end to the fastener 24.

The termination 22 is integral with the base 21. To achieve this, the lug 2 preferably comprises a back 25, which connects the connection termination 22 to the base 21. Advantageously, the back 25 forms an elongated wall orthogonal to the direction Z2. In other words, the back is parallel to direction X2. Preferably, a front end of the back 25 belongs to the connection termination 22. Preferably, the folded fasteners 23 and 24 protrude from the back 25 in the direction Z2. A rear end of the back 25 and the fasteners 23 and 24 form the base 21 of the lug 2.

The termination 22 is configured to be coupled with one of the terminals of capacitor C, for example terminal 11, to electrically connect the terminal 11 to the cables 13 and 14 via the lug 2. The terminal 11 is shown schematically in FIG. 1 in dashed lines. In the example shown, the terminal 11 is generally flat and rectangular with bevelled corners. However, in practice, the terminal 11 can be shaped differently.

In the present example, the terminal 11 connected to the lug 2 belongs to the capacitor C, but the lug 2 is adapted to be connected to the terminal of an electrical component other than a capacitor, in order to link that electrical component to one or more conductor cables, each conductor cable being connected to any desired electrical device, which may be different from the motor and the switch of the present example. The term “electrical component” includes electronic components.

The coupling of the termination 22 with terminal 11 is preferably reversible, in that the termination 22 is configured to allow a technician to remove the terminal 11 from the lug 2, to disconnect the lug 2 from the capacitor C if necessary.

Advantageously, the termination 22 forms a female endpiece, receiving the terminal 11 within it for coupling, i.e. enabling the terminal 11 to be plugged into the termination 22, preferably orientated opposite to the direction X2. The terminal 11 is preferably plate-shaped and, when received in the termination 22, extends in a plane orthogonal to the direction Z2. Received in this way, the terminal 11 is orientated parallel to direction X2, but orientated opposite to the direction X2.

To enable the terminal 11 to be plugged into the termination 22, the termination 22 advantageously comprises, in addition to the front end of the back 25, two longitudinal edges 26 and two wings 27. The longitudinal edges 26 are distributed along the direction Y2, on either side of the back 25 and the wings 27. Each longitudinal edge 26 projects from the back 25 in the direction Z22. Each wing 27 projects from one of the longitudinal edges 26 towards the other wing 27. Each wing 27 is thus connected to the back 25 via one of the edges 26. The pair of wings 27 is at a distance from the back 25 in the direction Z2. When the terminal 11 is coupled with the termination 22, the tab is received between the edges 26 in the direction Y2, and between the back 25 and the wings 27 in the direction Z2. Preferably, the terminal 11 is slightly pinched, in a resilient manner, between the back 25 and the wings 27, to be held in place in the termination 22. To this end, as can be seen in FIG. 1, each wing 27 respectively behaves like a respective flexible blade, for example.

As the terminal 11 is received in the termination 22, it is electrically connected to the conductors 13 and 14 attached to base 21, via the lug 2.

The lug 2 advantageously comprises two teeth 31 and 32. Preferably, the tooth 31 is formed at the rear of one of the wings 27 and the tooth 32 is formed at the rear of the other of the wings 27. More generally, it is advantageous for the teeth 31 and 32 to be formed at the rear of the connection termination 22. Advantageously, the teeth 31 and 32 are arranged transversely opposite the back 25, i.e. in the direction Z2 with respect to the back 25. Each tooth 31 and 32 projects transversely from the connection termination 22, opposite the back 25. In other words, in this example, the teeth 31 and 32 project in the direction Z2. In this way, each tooth 31 and 32 protrudes from the connection termination 22 in the direction Z2. Preferably, in the direction Z2, the teeth 31 and 32 do not protrude from the base 21, preferably ending either substantially at the same height as the fasteners 23, or slightly below the fasteners 23. The teeth 31 and 32 form a rear locking abutment 33 and a rear locking abutment 34 respectively, on their faces orientated opposite from the direction X2. In other words, the abutments 33 and 34 are formed by the free ends of the teeth 31 and 32 respectively.

The cover 5 is electrically insulating, for example by being made entirely of an electrically insulating material such as a polymer plastic. Preferably, the cover 5 is produced by injection moulding of polymer plastic. The cover 5 is preferably made of a single piece, formed as one part.

The cover 5 defines a longitudinal direction X5, known as the “insertion direction”, and two transverse directions, namely a lateral direction Y5 and a height direction Z5. The directions X5, Y5 and Z5 are perpendicular to each other and are fixed relative to the cover 5. Unless otherwise stated, terms such as “longitudinal”, “front” and “rear” refer to the direction X5, terms such as “transverse” refer to the directions Y5 and Z5, the term “lateral” refers to the direction Y5 and the term “height” refers to the direction Z5.

The cover 5 has a tubular wall 51, which is generally tubular in shape along the direction X5 and defines an internal volume of the cover 5. The tubular wall 51 forms a connection end 52, which is a front longitudinal end, and a rear end 53, the connection end 52 being arranged along the direction X5 with respect to the rear end 53.

The cover 5 is configured to receive the lug 2 inside the tubular wall 51, i.e. in the interior volume, with the lug 2 positioned in the cover 5 in a nominal orientation shown in FIG. 3. Alternatively, the lug 2 positioned in the cover in the incorrect orientation is shown in FIG. 4. For normal use of the cover 5, it is intended that the lug 2 is received in the cover 5 in the nominal orientation.

The tubular wall 51 advantageously comprises a bottom wall 56, which connects the ends 52 and 53 together. The front of the wall 56 forms part of the end 52 and the rear of the wall 56 forms part of the end 53. The bottom wall 56 is substantially flat and extends perpendicularly to the direction Z5.

The tubular wall 51 advantageously comprises a side wall 57 and a side wall 58, which connect the ends 52 and 53 to one another. The front of the walls 57 and 58 form part of the end 52 and the rear of the walls 57 and 58 form part of the end 53. The walls 57 and 58 are arranged on either side of the wall 56 in the direction Y5, and project from the wall 56 in the direction Z5. In other words, the walls 57 and 58 are distributed opposite each other in the direction Y5. The walls 57 and 58 are substantially flat and extend perpendicular to the direction Y5.

The tubular wall 51 advantageously comprises a front top wall 59 and a rear top wall 60. The top wall 59 connects the walls 57 and 58 to the connection end 52, forming part of the connection end 52. The top wall 59 extends away from the wall 56 in the direction Z5. Preferably, the wall 59 extends in a plane perpendicular to the direction Z5. The top wall 60 connects the walls 57 and 58 to one another at the rear end 53, thereby forming part of the rear end 53. The top wall 60 extends away from the wall 56 in the direction Z5. Preferably, the wall 60 extends in a plane perpendicular to the direction Z5. Preferably, the wall 60 is further away from wall 56 than the wall 59 is in the direction Z5. In this way, the connection termination 22 can be received within the end 52, between the walls 56 and 59, but the end 52 is too narrow to receive the base 21. On the other hand, the distance between the wall 60 and the wall 56 is sufficient to allow the termination 22 to pass through when the lug 2 is inserted into the cover, but also to receive the base 21 when the lug 2 is positioned in the nominal orientation.

At the connection end 52, the cover 5 delimits an opening 54, known as the “connection opening”, which emerges in the interior volume of the cover 5 and emerges in the outside in the direction X5. More specifically, the contour of the connection opening 54 is formed by the front of the walls 56, 57, 58 and 59. The opening 54 preferably has the shape of a notch, flattened in the direction Z5, corresponding to the shape of the terminal 11, to allow the terminal 11 to pass through the opening 54 in order to be received in the interior volume of the cover 5.

At the rear end 53, the cover 5 delimits an opening 55, known as the “insertion opening”, which emerges in the interior volume of the cover 5 and emerges in the outside orientated opposite to the direction X5. More specifically, the contour of the insertion opening 54 is formed by the rear of the walls 56, 57, 58 and 60. Each wall 56, 57 and 58 connects the openings 54 and 55 together. The opening 55 is preferably more open in the direction Z5 than the opening 54, so that the lug 2 can be inserted into the internal volume of the cover 5 via the opening 55, in particular completely, when the lug 2 is in the nominal orientation.

Preferably, the cover 5 delimits an opening 61, known as the “intermediate opening”. Preferably, the cover 5 comprises no openings other than 54, 55 and 61. At the front, the opening 61 is delimited by a rear transverse edge 62 belonging to the wall 59. Laterally, the opening 61 is delimited by a longitudinal edge 63 belonging to the wall 57 and a longitudinal edge 64 belonging to the wall 58. In other words, the opening 61 is located between the openings 54 and 55, in the direction X5, and opposite the wall 56, in the direction Z5. At the rear, the opening 61 is delimited by the wall 60. Advantageously, the edges 62, 63 and 64 project in the direction Z5, so as to protrude from the wall 59 in the direction Z5. In other words, each edge 62, 63 and 64 respectively forms a raised or projecting rib in the direction Z5, i.e. towards the outside of the cover 5. These edges 62, 63 and 64 being raised in this way reduces the risk of accidental insertion of an object or a technician's finger into the interior volume of the cover 5, thus ensuring electrical insulation when the lug 2 is received within the cover 5.

The cover 5 preferably comprises a retaining blade 65. The retaining blade 65 is arranged in the opening 61, i.e. is framed by the opening 61. Preferably, the blade 65 is attached to the tubular wall 51 via the wall 60, at a rear edge of the opening 61. As can be seen more clearly in FIG. 2, the retaining blade preferably extends obliquely from the wall 60 in the direction X5, so that a free end of the blade 65 is arranged opposite the direction Z5 with respect to a base of the blade 65, via which the blade 65 is attached to the wall 60. The free end of the blade forms a front locking abutment 66, which faces in the direction X5. Preferably, the abutment 66 of the blade 65 is located inside the opening 61, close to the edge 62. The abutment 66 is remote from the bottom wall 56. The abutment 66 is located between the walls 57 and 58, preferably halfway between them.

The retaining blade 65 is resiliently deformable from a resting configuration, shown in FIG. 2, to a locking configuration, shown as a long dashed line in FIG. 3, or from the resting configuration to an unlocking configuration, shown partially as a dotted line in FIG. 3. In FIG. 3, the reference 66 indicates the front locking abutment when the blade 65 is in the resting configuration, the reference 66′ indicates the front locking abutment when the blade 65 is in the locking configuration, and the reference 66″ indicates the front locking abutment when the blade 65 is in the unlocking configuration. When moving from the resting configuration to the unlocking configuration, the front locking abutment 66 is displaced in particular along the direction Z5, i.e. is lifted towards the outside of the cover 5 through the opening 61. This prevents the blade 65 from being accidentally put into the unlocking configuration, in that pressing on the blade 65 from the outside, in the direction orientated opposite to the direction Z5, does not put the blade 65 into the unlocking configuration. In other words, the abutment 66 is moved in its unlocking configuration away from the wall 56, in particular using an external tool, such as a screwdriver or other fine tool. When the lug 2 is received in the cover 5, the abutment is held in the locking configuration by the lug 2. In this example, where the resting configuration is distinct from the locking configuration, the blade 65 tends to resiliently return to the resting configuration when it is in the locking configuration. The blade 65 tends to resiliently return to the resting configuration when it is in the release configuration. Preferably, in all configurations, the blade 65 remains inside the opening 61 without projecting beyond the edges 62, 63 and 64.

Preferably, at least for the locking configuration, the distance between the retaining blade 65 and the edge 63, measured parallel to the direction Y5, is less than 1.2 mm. Preferably, the distance between the retaining blade 65 and the edge 64, measured parallel to the direction Y5, is less than 1.2 mm. Preferably, the distance between the retaining blade 65 and the edge 62, measured parallel to the direction X5, is less than 1.2 mm. This reduces the risk of accidental insertion of an object or a technician's finger into the interior volume of the cover 5, thus preventing the electrical risk when the lug 2 is received within the cover 5.

The cover 5 preferably comprises two ribs 67 and 68, known as “retaining ribs”, which can be seen in particular in FIG. 5. The ribs 67 and 68 are arranged inside the cover 5, between the openings 54 and 55. The ribs 67 and 68 are arranged on either side of the blade 65. In other words, the abutment 66 is preferably positioned between the ribs 67 and 68, in the direction Y5. The rib 67 connects the base of the blade 65 or the wall 60 to the wall 57. The rib 68 connects the base of the blade 65 or the wall 60 to the wall 58. The ribs 67 and 68 delimit the opening 61 at the base of the blade 65.

Preferably, on the inside of the cover 5, parallel to the direction Y5, the rib 67 projects from wall 57 towards the rib 68 and the rib 68 projects from the wall 58 towards the rib 67. The ribs 67 and 68 are therefore arranged in a horseshoe shape. Preferably, the ribs 67 and 68 are formed starting from the wall 60 and extend towards the interior of cover 5, towards the wall 56. The ribs 67 and 68 start at the edge of the wall 60 and terminate at a respective inner end, preferably at the wall 59. In other words, each rib 67 and 68 is interrupted so that it does not reach the wall 56. Each rib 67 and 68 respectively forms, at its inner end, a rear retaining abutment 71 and 72. These abutments 71 and 72 face away from the direction X5 and are preferably positioned at the wall 59. The abutments 71 and 72 are fixed, unlike the abutment 66, which is mobile. The abutments 71 and 72 are positioned between the insertion opening 55 and the connection opening 54, so that they do not prevent partial insertion of the lug 2 when the lug 2 is in the incorrect orientation. It should also be noted that the abutments 71 and 72 are separate from the abutment 66, i.e. they are formed by a structure, in this case the ribs 67 and 68, which is separate from the structure forming the abutment 66, in this case the blade 65.

To insert the lug 2 into the cover 5, whether in the nominal orientation or the incorrect orientation, the connection termination 22 is inserted first, via the insertion opening 55, by moving the lug 2 in the direction X5 and orientating the lug 2 so that the direction X2 runs in the same orientation as the direction X5. Once the connection termination 22 has been received, the lug 2 continues to be inserted until at least part of the base 21 also passes through the opening 55, at least when the lug 2 is in the nominal orientation, and preferably also when the lug is in the incorrect orientation. In any case, the lug 2 is advantageously inserted when it is already permanently attached to the cables 13 and 14 via the base 21. To be inserted into the cover 5, the lug 2 is moved in the direction X5 until it comes to rest in the direction X5 against the abutments 71 and 72, if the lug 2 is in the incorrect orientation, or until it is captured in the cover 5, by cooperation of the blade 65 with the abutments 33 and 34, if the lug 2 is in the nominal orientation. In both cases, the lug 2 is partially or fully positioned in the cover 5.

Preferably, once the lug 2 has been received in the cover 5, whether in the nominal or incorrect orientation, the lug 2 is arranged between, on the one hand, the bottom wall 56 and the abutment 66, along the direction Z5 and, on the other hand, the bottom wall 56 and the abutments 71 and 72. Preferably, the abutments 71 and 72 are arranged laterally on either side of the teeth 31, 32 of the lug 2, particularly for nominal orientation.

As shown in FIG. 3, when lug 2 is received in the nominal orientation, the directions X2 and X5 have the same orientation and point the same way, the directions Y2 and Y5 have the same orientation and point the same way, the directions Z2 and Z5 have the same orientation and point the same way. The connection termination 22 is received inside the connection end 52 and the base 21 is received inside the rear end 53. Advantageously, the lug 2 is entirely housed inside the cover 5 and is thus electrically insulated from the outside.

To give more detail, in this configuration, the back 25 advantageously rests flat against the bottom wall 56. Advantageously, the edges 26 are supported laterally between the walls 57 and 58, against said walls 57 and 58. The lug 2 is thus positioned in the cover 5 along directions X2 and Y2. The wings 27 extend along and close to the wall 59. When the lug 2 is inserted in the nominal orientation, the back 25 slides along the wall 56 and the edges 26 slide along the walls 57 and 58, which guides the lug 2 as it slides along the direction X5. When received in the nominal orientation, the connection termination 22 opens into the connection opening 54. As a result, the terminal 11 of the electrical component can be coupled with the connection termination 22 through the connection opening 54. In this configuration, the connection termination 22 preferably abuts against the periphery of the connection opening 54 in the direction X5.

While the lug 2 is received in the nominal orientation, the base 21 is fully received in the rear end 53, i.e. the base 21 has also passed through the opening 55 during insertion. The distance between the walls 56 and 60 is sufficient to accommodate the base 21, which is likely to be thicker than the connection termination 22. The ends of cables 13 and 14 are also housed within end 53, while cables 13 and 14 are attached to the lug 2. The space available in the rear end 53 can accommodate the base of a larger lug, either to be attached to more conductor cables, or for conductor cables with a larger cross-section. Preferably, as shown in FIG. 3, the base 21 is pushed beyond the insertion opening 55, so as to be positioned in the direction X5 with respect to the insertion opening 55. This reduces the electrical risk by preventing a foreign body or a person from accidentally coming into contact with the received lug 2 via the opening 55.

When the lug 2 is inserted in the nominal orientation, the lug 2 resiliently deforms the blade 65 from its rest configuration to a passage configuration, which is beyond the locking configuration, in particular via the teeth 31 and 32. The teeth 31 and 32 are located along the direction Y5, at the blade 65. The teeth 31 and 32 act on the blade 65 when they are at the free end of the blade 65 in the direction X5. Once, parallel to the direction X5, the abutments 33 and 34 have passed the front stop for locking the cover 5, the blade 65 resiliently returns to the locking configuration. The front locking abutment is then positioned in direction X2 behind the two rear locking abutments 33 and 34 formed by the teeth 31 and 32. The lug 2 is then captured within the cover by the mechanical cooperation of abutments 33 and 34 with the abutment 66, and prevents the lug 2 from being coming out in the orientation opposite to the direction X5.

In the example shown, the lug 2 prevents the blade from returning to the resting configuration when the blade 65 is in the locking configuration and the lug 2 is in the nominal orientation. Because of the resilient nature of the blade 65, the free end of the blade 65 tends to press slightly on the lug 2 in the direction Z5, so that the blade 65 tends to maintain the mechanical cooperation of the abutment 66 with the abutments 33 and 34.

In this example, the locking configuration is distinct from the resting configuration. However, it can be envisaged that the resting and locking configurations are the same.

While the lug 2 is thus received in the nominal orientation, it is possible to unlock the lug 2 by deforming the blade 65 to the unlocking configuration, from the outside of the cover 5, via the opening 61. For example, a tool, such as a flathead screwdriver, can be inserted into the notch formed between the edge 62 and the free end of the blade 65 to lift the blade 65. In the release configuration, the free end of the blade 65 is moved into a position where the abutment 66″ is offset from the abutments 33 and 34, advantageously in the direction Z5. The abutment 66″ then does not prevent the lug 2 from being withdrawn from the cover 5, via the opening 55, in the orientation opposite to the direction X5.

When the lug 2 is inserted into the cover 5 in the nominal orientation, the lug 2 does not abut against the abutments 71 and 72. In particular, the connection termination 22 passes over the abutments 71 and 72, passing between the wall 56 and the abutments 71 and 72, parallel to the direction Z5 and the teeth 31 and 32 pass between the abutments 71 and 72 in the direction Y5. Preferably, at least part of the base 21 can also pass over the abutments 71 and 72, in that the base 21, which is narrower than the termination 22 in the direction Y5, passes between the abutments 71 and 72. For example, once the lug 2 has been received in the cover 5, the fasteners 23 are arranged between the abutments 71 and 72, along the direction Y5. More generally, the abutments 71 and 72 are advantageously arranged so as not to oppose the insertion of the lug 2 into the cover 5, when the lug 2 is in the nominal orientation.

As shown in FIG. 4, when the lug 2 is received in the cover 5 in the incorrect orientation, the directions X2 and X5 point the same way, the directions Y2 and Y5 point in opposite ways but in the same orientation and directions Z2 and Z5 point in opposite ways. As shown in FIG. 4, when the lug 2 is positioned in this way, the direction X2 is at an angle to the direction X5 and the direction Z2 is at an angle to the direction Z5. In other words, relative to the nominal orientation, the lug 2 has rotated by half a turn in roll about a longitudinal axis, parallel to the X5 direction, made an oblique rotation in pitch about a lateral axis, parallel to the Y5 direction, and made no yaw movement, about a height axis, parallel to the direction Z5. Preferably, about the lateral axis parallel to the direction Y5, the axis X2 is inclined obliquely at an angle of between 5 and 10 degrees relative to the axis X5. Positioned obliquely in this way, the base 21 is higher in the direction Z5 than the termination 22.

When the lug 2 is received in the cover 5 in the incorrect orientation, the rear locking abutments 33 and 34 of the lug 2 are arranged opposite the blade 65 within the cover 5. In other words, the abutments 33 and 34 cannot cooperate with the abutment 66 to retain the lug 2 within the cover 5. Preferably, the insertion of the lug 2 in the incorrect orientation is limited with the abutments 33 and 34 positioned offset, with respect to the abutment 66, in the orientation opposite to the direction X5. In particular, the teeth 31 and 32 are directed towards the wall 56, and even preferably bear against the wall 56 in the orientation opposite to the direction Z5. More generally, in the incorrect orientation, the lug 2 cannot be fully inserted into the cover, is not retained within the cover 5 and can be freely removed by sliding in the orientation opposite to the direction X5.

When the lug 2 is received in the cover 5 in the incorrect orientation, it is intended that the lug 2 rests against the wall 56, not via the back 25, but at least via the teeth 31 and 32. In addition to the teeth, the lug 2 rests against the wall 56 either via the termination 22 as shown in FIG. 4, in particular via the wings 27 or edges 26, or via the base 21, in particular via the fasteners 23 or possibly via the end of the cable(s) attached to it. Since the teeth 31 and 32 project from the termination 22 in the direction Z2 and/or the base 21 projects beyond the teeth 31 and 32 in the direction Z2, in particular the fasteners 23, pressing the lug 2 against the wall 56 places the lug 2 in the above-mentioned oblique orientation with respect to the cover 5 and the insertion direction X5. It is then clearly visible to the technician that the lug 2 is incorrectly orientated.

When the lug 2 is inserted with the incorrect orientation, it is not the back 25 that slides along the wall 56, but the wings 27, the teeth 31 and 32 and/or the fasteners 23. When the lug 2 is inserted in the incorrect orientation, the edges 26 slide along the walls 57 and 58, which guides the lug 2 as it slides along the direction X5.

When the lug 2 is received in the cover 5 in the incorrect orientation, the back 25 is turned towards the walls 59 and 60, i.e. is turned away from the bottom wall 56. As shown in FIG. 4, the lug 2 thus received in the cover 5 comes into abutment against the abutments 71 and 72 in the direction X5, preferably via the back 25. In practice, the back 25 advantageously comes to bear obliquely against the abutments 71 and 72, in the direction X5, due to the inclination of the back 25 obliquely with respect to the direction X5, about the lateral axis parallel to the direction Y5. More generally, as the lug 2 rests against the abutments 71 and 72, the lug 2 is retained by the abutments 71 and 72, so that it cannot be inserted further into the cover 5.

By stopping the lug 2 in the incorrect orientation, the lug 2 is held further back from the end 52 than when the lug 2 is received in the cover with the nominal orientation.

In particular, the termination 22 does not reach the end 52, or is only partially inserted into the end 52, whereas it was fully inserted, or capable of being fully inserted, into the end 52 for the nominal orientation of the lug 2. As a result, it is not possible to connect the terminal 11 with the termination 22, as the termination 22 is set too far back inside cover 5 with respect to the opening 54. Optionally, the abutments 71 and 72 are arranged so that the terminal 11 cannot even reach the termination 22 when the terminal 11 is received in the cover 5 via the opening 54. In addition, it is optionally provided that the end 52, in particular the opening 54, as well as the termination 22, are shaped so that the terminal 11 cannot connect with the termination 22 when the termination 22 is orientated obliquely in the cover 5, which is the case when the lug 2 is received in the incorrect orientation. There is therefore no risk of the technician being able to connect lug 2 to capacitor C or to the electrical component when the lug 2 is incorrectly orientated within the cover 5.

Advantageously, due to abutting against the abutments 71 and 72 in this way, the base 21 is only partially received in the cover 5 and protrudes partially or entirely from the cover 5 via the opening 55. Here, at least the fasteners 24 are kept outside the cover 5, and preferably part of the fasteners 23. It is then clearly visible to the technician that the lug 2 is incorrectly orientated, with the base 21 protruding, whereas, in the nominal orientation, the entire lug 2 is advantageously housed in the cover 5.

Advantageously, when the lug 2 is received in the incorrect orientation against the abutments 71 and 72, the blade 65 rests against the back 25. In this position, the back 25 advantageously holds the blade 65 away from its resting configuration, in a deformed configuration, which may correspond, for example, to the unlocking configuration. As the blade 65 tends to resiliently return to its resting configuration, it exerts a force against the back 25.

Each characteristic described above for one of the embodiments or variants can be implemented in the other embodiments and variants described above, insofar as this is technically possible.

1.- A lug-cover assembly comprising:
a lug, which is electrically conductive and comprises:
a base configured to be permanently attached to at least one conductive cable, and
a connection termination, integral with the base and configured to be coupled with a terminal of an electrical component to electrically connect the terminal to said at least one conductive cable via the lug; and
a cover, which is electrically insulating and comprises:
an insertion opening, the lug being configured to be inserted into the cover, in an insertion direction, by first passing the connection termination through the insertion opening,
a front locking abutment, which abuts against a rear locking abutment belonging to the lug, in the insertion direction, when the lug is positioned in the cover in a nominal orientation, to prevent of the lug from coming out of the cover via the insertion opening,
a connection end, which is arranged in the insertion direction with respect to the insertion opening, which receives the connection termination when the lug is positioned in the cover in the nominal orientation and which has a connection opening, intended to be traversed by the terminal of the electrical component when the connection termination is connected to said terminal while the lug is positioned in the cover in the nominal orientation,
and
a rear retaining abutment separate from the front locking abutment, the rear retaining abutment being arranged between the insertion opening and the connection opening so that, when the connection termination of the lug is inserted into the insertion opening of the cover with the lug in an incorrect orientation, the lug abuts against the rear retaining abutment in the insertion direction, and is thereby held back from the connection end, the rear retaining abutment being arranged to allow passage of the rear locking abutment, when the lug is inserted into the cover in the nominal orientation.

2.- The lug-cover assembly according to claim 1, wherein:
when the removal of the lug is prevented by abutment of the front locking abutment against the rear locking abutment, the lug is fully received in the cover; and
when the lug is in abutment in the insertion direction against the rear retaining abutment, the base projects out of the cover through the insertion opening.

3.- The lug-cover assembly according to claim 1, wherein the rear retaining abutment is formed on a tubular wall of the cover.

4.- The lug-cover assembly according to claim 1, wherein the cover comprises two retaining ribs, which form the rear retaining abutment, the two retaining ribs being arranged longitudinally between the connection end and the insertion opening and transversely on either side of the insertion opening.

5.- The lug-cover assembly according to claim 1, wherein:
the cover comprises a bottom wall, connecting the insertion opening to the connection opening;
the lug comprises at least one tooth, which projects transversely from the connection end and forms the rear locking abutment; and
when the lug is positioned in the cover in the incorrect orientation, the lug rests against the bottom wall via said at least one tooth the lug thus being held in an oblique orientation relative to the insertion direction, about a lateral axis perpendicular to the insertion direction.

6.- The lug-cover assembly according to claim 5, wherein:
the lug comprises a back, which connects the connection termination to the base and which is transversely opposite the rear locking abutment;
the lug is slidably guided in the insertion direction by sliding the back along the bottom wall, when the lug is inserted into the cover in the nominal orientation; and
the lug comes to rest against the rear retaining abutment via the back when the lug is positioned in the cover in the incorrect orientation.

7.- The lug-cover assembly according to claim 1, wherein:
the cover comprises an intermediate opening, arranged between the insertion opening and the connection opening and emerging in the interior of the cover
the cover comprises a retaining blade, which is arranged in the intermediate opening, a free end of which forms the front locking abutment, the retaining blade being elastically deformable, between:
a locking configuration, where the front locking abutment is positioned to abut against the rear locking abutment, to prevent the lug from coming out, and
an unlocking configuration, where the front locking abutment does not prevent the lug from coming out of the cover, even when the lug is positioned in the cover in the nominal orientation; and
the retaining blade is configured so that:
it can be brought into the unlocking configuration from outside the cover via the intermediate opening, when the retaining blade is in the locking configuration, and
it will resiliently return to the locking configuration when the retaining blade is in the unlocking configuration.

8.- The lug-cover assembly according to claim 7, wherein: the cover is configured so that the front locking abutment can be moved from the locking configuration to the unlocking configuration by moving the front locking abutment away from the lug using a tool.

9.- The lug-cover assembly according to claim 7, wherein the intermediate opening is delimited by at least one edge belonging to the cover, said at least one edge forming a rib which is in relief towards the outside of the cover.

10.- A drive system for operating a closure, occultation, or solar protection device, comprising:
the lug-cover assembly according to claim 1, the lug being positioned in the cover in the nominal orientation;
an electric motor,
a conductive cable, electrically connecting the electric motor and the lug, by being permanently attached to the base of the lug; and
an electrical component, consisting of a capacitor and having a terminal coupled with the connection termination of the lug, through the connection opening of the cover.
